(19) United States
(12) Patent Application Publication
(10) Pub. No.: US 2008/0025655 A1
(43) Pub. Date: Jan. 31, 2008

(54) Bearing retainer

(75) Inventors: Alex S. Creviston, Muncie, IN (US); Scott William Bitzer, Fishers, IN (US)

Correspondence Address: ICE MILLER LLP, ONE AMERICAN SQUARE, SUITE 3100, INDIANAPOLIS, IN, 46282-0200, US

(73) Assignee: Remy International, Inc., Anderson, IN (US)

(21) Appl. No.: 11/881,150

(22) Filed: Jul. 25, 2007

Related U.S. Application Data
(60) Provisional application No. 60/833,122, filed on Jul. 25, 2006.

(51) Int. Cl. F16C 29/06

(52) U.S. Cl. 384/45

(57) ABSTRACT

A bearing retainer for use with a bearing having an outside diameter which is to be received in the bearing retainer and to be mounted into a cavity having an inside diameter includes a bearing-engaging wall having a minimum inside diameter when the bearing retainer is in a non-deformed state approximately equal to but slightly less than the outside diameter of the bearing to be received therein, an outer cavity-engaging wall having a maximum outside diameter when the bearing retainer is in a non-deformed state approximately equal to the inside diameter of the cavity within which the bearing retainer is to be received, a web wall extending between and coupling the bearing-engaging wall and the cavity-engaging wall and wherein the bearing-engaging wall, cavity-engaging wall and web wall are fabricated from a material capable of elastic and plastic deformation so that upon insertion of the bearing into the bearing retainer the bearing-engaging wall is deformed to secure the bearing within the bearing retainer and upon insertion of the bearing retainer into the cavity the web wall is deformed to induce the cavity-engaging wall to exert a force against a side wall of the cavity to secure the bearing retainer within the cavity.

### RELATED APPLICATIONS

This application claims the benefit of co-pending U.S. Provisional Application 60/833,122 filed Jul. 25, 2006, the disclosure of which is hereby incorporated herein by this reference.

### BACKGROUND AND SUMMARY

This invention relates to bearing retainers and more particularly to bearing retainers for adapting bearings have the same outside diameter to fit into cavities or bores having a range of inside diameters.

Bearings are utilized in various applications to reduce friction and the heat generated thereby. Often bearings are inserted in bearing-receiving bores or cavities of frames or machine housings from which rotating shafts extend or from which stationary shafts extend about which the frame or housing rotates. Thus, bearings are typically manufactured with an outside diameter configured to be received in the bearing-receiving bore or cavity of the housing and are often configured to be press-fit into the bearing-receiving bore or cavity. Bearings are also configured with central openings having inside diameters configured to allow the bearing to be received on a shaft and are also often configured to be pressed onto the shaft or to have a shaft pressed into the central opening.

Often the bearing-receiving bores or cavities of housings and frames having differing inside diameters are utilized with shafts having the same outside diameter. In such a case bearings having the appropriate configuration each differently configured cavity or bore must be manufactured. Also, while many bearing-receiving bores or cavities in frames and housing have nominal inside diameters that are the same, it is often the case that the actual inside diameters of the bearing-receiving bores or cavities having the same nominal inside diameter differ slightly in actual diameter due to manufacturing tolerances, wear, and or other factors including the temperature of the frame or housing. Thus, bearing users would appreciate a device that enables a bearing manufactured to similar outside diameter specifications to be utilized in conjunction with the bearing-receiving bores or cavities in housings and frames that have slightly different inside diameters.

Some users of bearings have utilized thermoplastic bearing retainer inserts in the past to dispose between the housing and the bearing being received therein. Typically such thermoplastic bearing retainer inserts are manufactured within twenty micron tolerances with regard to the outside and inside diameters for appropriate fit within a bore in a housing and for receiving a bearing therein. Unfortunately since many housings are manufactured from aluminum and most bearing races are manufactured from steel, the thermal expansion rates of the housing, bearing and insert may differ greatly possibly resulting in failure of the thermoplastic insert to retain the bearing in proper orientation relative to the housing.

Thus, bearing users would appreciate a device that enables a bearing manufactured to similar outside diameter specifications to be utilized in conjunction with the bearing-receiving bores or cavities in housings and frames that have slightly different inside diameters which bearing insert has a rate of thermal expansion more closely related to the thermal expansion rate of the housing and bearing than the thermal expansion rate of the current thermoplastic inserts. The proposed bearing retainer, bearing retainer cup or tolerance ring uses spring force to ‘take up’ the delta in thermal expansions.

The disclosed bearing bore adapter device or bearing retainer is configured to facilitate utilizing a bearing having a similar outside diameters with housings and frames having bores and cavities with differing, within a range, inside diameters.

According to one aspect of the disclosure, a bearing retainer for use with a bearing having an outside diameter which is to be received in the bearing retainer and to be mounted into a cavity having an inside diameter includes a frusto-conical inner bearing-engaging wall, and outer cavity-engaging wall and a web wall. The inner bearing-engaging wall has a minimum inside diameter when the bearing retainer is in a non-deformed state approximately equal to but slightly less than the outside diameter of the bearing to be received therein. The outer cavity-engaging wall has a maximum outside diameter when the bearing retainer is in a non-deformed state approximately equal to the inside diameter of the cavity within which the bearing retainer is to be received. The web wall extends between and couples the bearing-engaging wall and the cavity-engaging wall. The bearing-engaging wall, cavity-engaging wall and web wall are fabricated from a material capable of elastic and plastic deformation so that upon insertion of the bearing into the bearing retainer the bearing-engaging wall is deformed to secure the bearing within the bearing retainer and upon insertion of the bearing retainer into the cavity the web wall is deformed to induce the cavity-engaging wall to exert a force against a side wall of the cavity to secure the bearing retainer within the cavity.

Additional features and advantages of the invention will become apparent to those skilled in the art upon consideration of the following detailed description of a preferred embodiment exemplifying the best mode of carrying out the invention as presently perceived.

### BRIEF DESCRIPTION OF THE DRAWINGS

The present invention is illustrated by way of example and not limitation in the figures of the accompanying drawings in which like references indicate similar elements and in which:

FIG. 1 is a perspective view of one embodiment of a bearing retainer;

FIG. 2 is a top plan view of the bearing retainer of FIG. 1;

FIG. 3 is a bottom plan view of the bearing retainer of FIG. 1;

FIG. 4 is a sectional view taken along line 4-4 of the bearing retainer of FIG. 2;

FIG. 5 is an exploded partial sectional view of a housing having a bearing-receiving bore formed therein, the bearing retainer of FIG. 1, a bearing and a shaft;

FIG. 6 is a partially exploded partial sectional view similar to FIG. 5 with the shaft and portions of the bearing removed, wherein the bearing is received in the bearing retainer;

FIG. 7 is a partial sectional view similar to FIG. 5 of the assembled housing bearing retainer, bearing and shaft wherein the bearing is received on the shaft and in the bearing retainer which is received in the bearing-receiving bore of the housing;

FIG. 8 is a top plan view of a second embodiment of a bearing retainer;

FIG. 9 is a sectional view taken along line 9-9 of the bearing retainer of FIG. 8;

FIG. 10 is an exploded partial sectional view of a housing having a bearing-receiving bore formed therein, the bearing retainer of FIG. 8, a bearing and a shaft; and,

FIG. 11 is a partial sectional view similar to FIG. 10 of the assembled housing bearing retainer, bearing (with shaft not visible) wherein the bearing is received in the bearing retainer which is received in the bearing-receiving bore of the housing.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present invention includes any alterations and modifications to the illustrated embodiments and includes further applications of the principles of the disclosure as would normally occur to one skilled in the art to which this invention pertains.

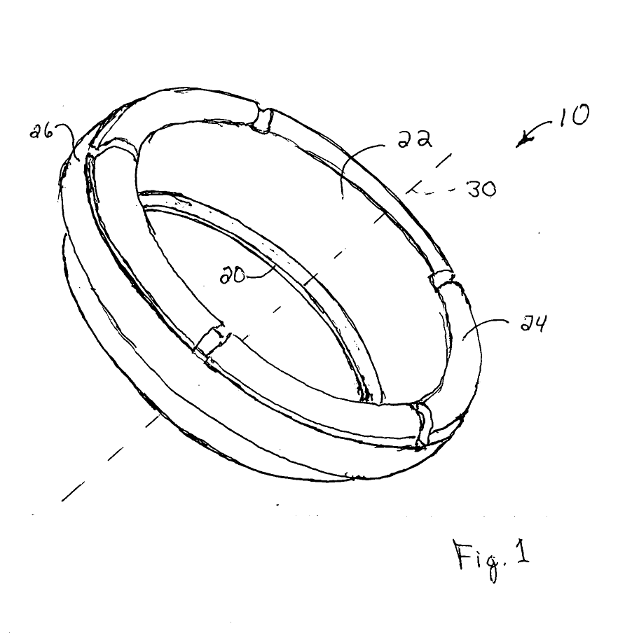

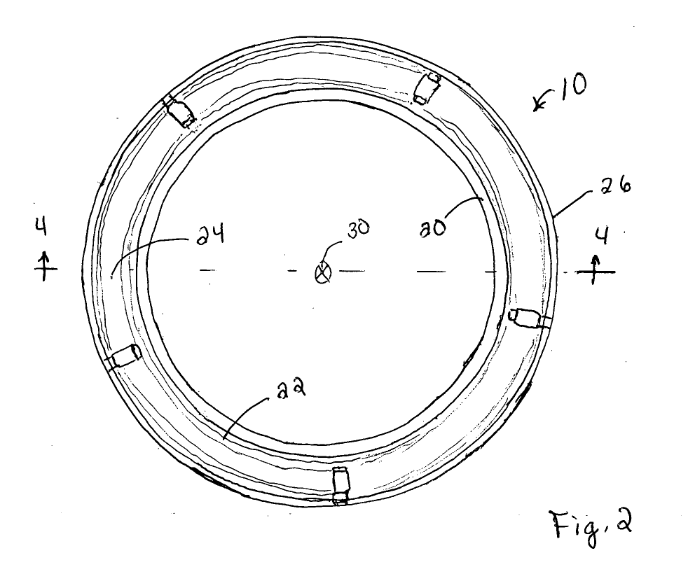

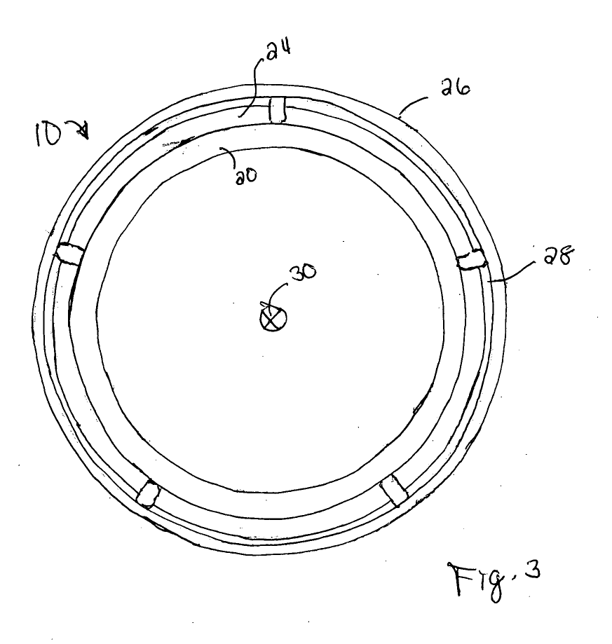

As shown, for example, in FIGS. 1-7, a tolerance ring, bearing retainer or bearing retainer cup 10 in accordance with one disclosed embodiment is configured for receipt in a cylindrical bore or cavity 12 formed in a housing or frame 14 and is configured to receive and retain a bearing 16 therein. While the disclosed embodiments of bearing retainer cups 10 and 110 are often referred to herein as a “bearing retainers”, the usage of such term should not be confused with the usage of the term “bearing retainer” to refer to that component of a bearing that maintains proper distance between rolling elements. While the illustrated embodiments of the bearing retainer cups 10 and 110 are shown as being utilized with a ball bearing 16 having an outer race and an inner race configured to have cylindrical outer surfaces extending perpendicular to a rotational axis, it is within the scope of the disclosure for the disclosed bearing retainer cups 10 and 110 to be utilized with other bearings such as cylindrical and needle bearings. Also, while the disclosed embodiments of bearing retainer cups 10 and 110 are shown as being used with a bearing 16 that is received on a shaft 18 the longitudinal axis of which is coincident with a rotational axis of the bearing 16, in appropriate situations, the disclosed bearing retainer cups 10 and 110 also may be used with thrust bearings which are not received on a shaft. Also, the disclosed bearing retainer cups 10 and 110 are configured for receipt in a bore or cavity 12 having cylindrical side walls but it is within the scope of the disclosure for the bearing retainer 10 to be configured for receipt in a bore or cavity having side walls of different configuration such as tapered or frusto-conical side walls.

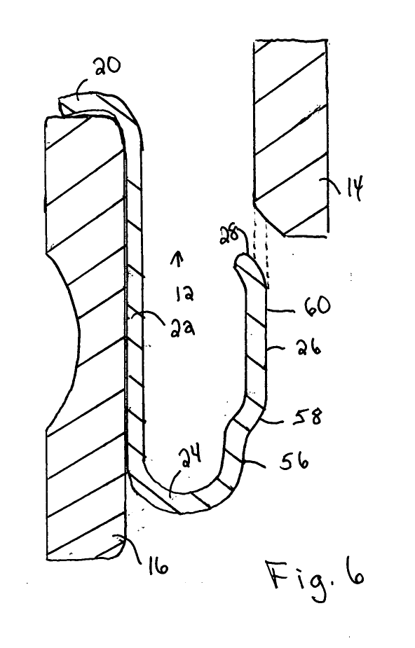

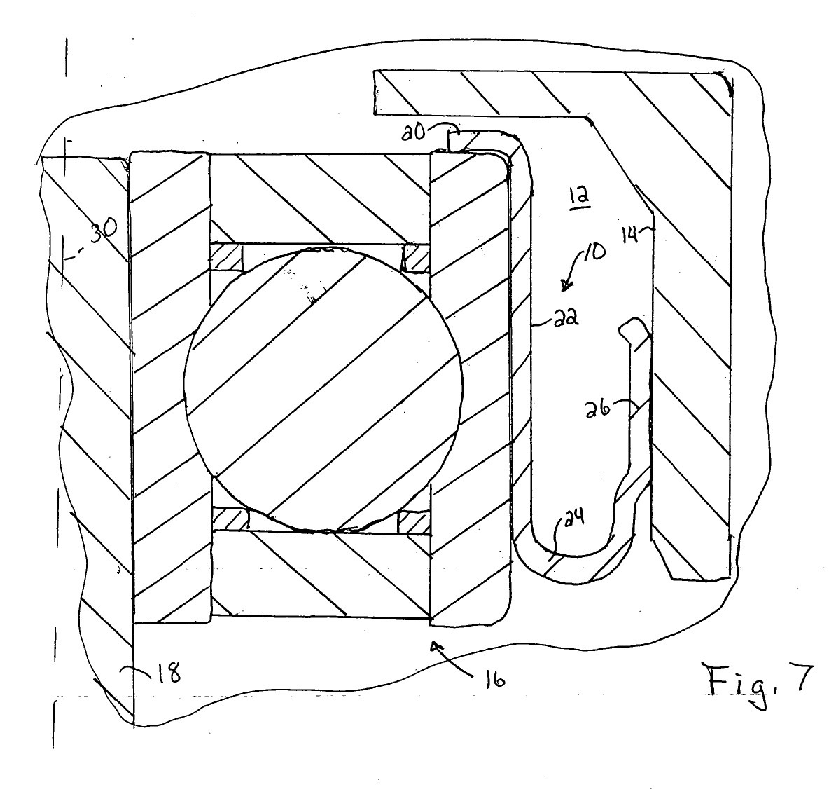

Referring again to FIGS. 1-7, the bearing retainer 10 includes a ring-shaped stop wall 20, a bearing-engaging interior side wall 22, a flexible web wall 24, a compound bore-engaging exterior side wall 26 and a tapered,lead-in lip wall 28. Prior to utilization, the ring-shaped stop wall 20, interior side wall 22, flexible web wall 24, exterior side wall 26 and lip wall 28 are all formed concentrically about an axis 30. However, in use, as shown for example, in FIGS. 6 and 7, certain of the walls of the bearing retainer 10 are deformed to facilitate securing the bearing 16 within the retainer 10 and the retainer 10 within the bore or cavity 12 in the housing or frame 14.

The bearing retainer 10 is formed from appropriate materials to allow for the deformation of the bearing retainer 10 in use and to securely hold the bearing 16 in the desired position and orientation relative to the housing or frame 14 in which it is inserted. In one example, the bearing retainer is fabricated from sheet metal such as 22ga, (“0.0299”±0.003”) (thickness) zinc coated AISI/SAE 1008, 1010 or 1015 low carbon steel sheet or strip metal. However, the thickness of and the type of material from which the bearing retainer 10 is fabricated may differ so long as the material provides sufficient elastic and plastic deformation and thermal expansion characteristics to provide the desired retention of the bearing retainer 10 and the bearing 16 received therein against longitudinal and rotational movement relative to the housing 14 in which the assembly is inserted. Additional considerations in selecting the material from which the bearing retainer 10 is fabricated include the desired axial and radial stiffness desired for the intended application of the bearing retainer 10. Because the housing 14 is often fabricated from aluminum and the outer race of the bearing 16 is often fabricated from steel, the utilization of zinc coated low carbon steel reduces the generation of galvanic currents and corrosion generated by contact between dissimilar metals. The utilization of low carbon steel, such as the types described above, also facilitates formation of the disclosed bearing retainers 10 and 110 utilizing a low cost stamping process. Such low carbon steels are well known for their formability, deep drawing capabilities and fatigue strength. Additionally, such low carbon steels are preferred to other materials, such as stainless steel, that might be utilized to fabricate a bearing retainer in accordance with the disclosure because of their relative lower cost.

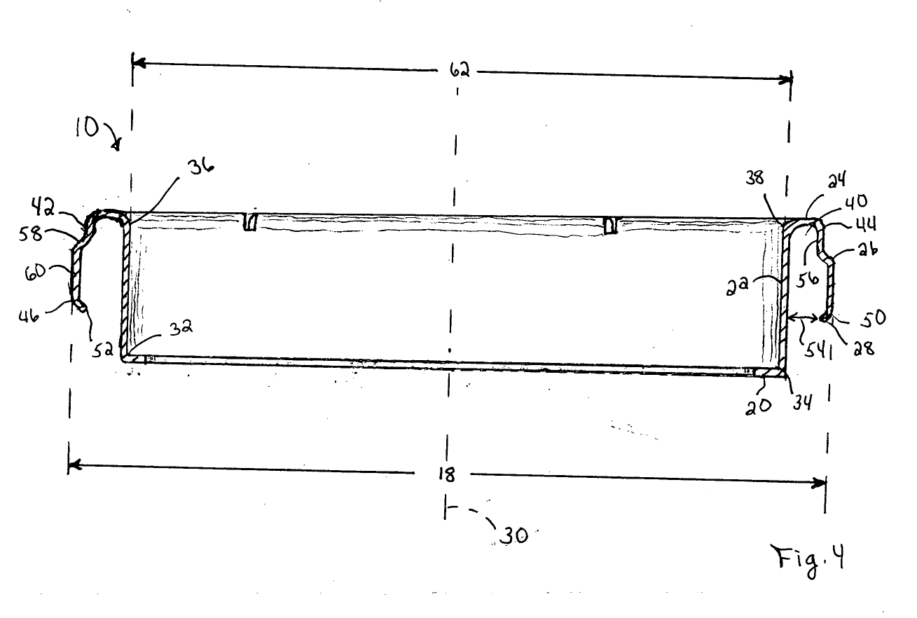

FIGS. 1-5 show the bearing retainer 10 in a non-deformed state prior to insertion into a bore or cavity 12 of a housing 14 and prior to receiving a bearing 16 therein. As shown, for example, in FIGS. 1-5, and more particularly in FIG. 4, ring-shaped stop wall 20 is coupled at an outer edge 32 to, and extends inwardly from, a distal edge 34 of the substantially cylindrically-shaped bearing-engaging interior side wall 22. Illustratively, the bearing-engaging interior side wall 22 is substantially cylindrical exhibiting an approximately one degree taper relative to the axis of the bearing retainer 10. Thus, the inside diameter of the interior side wall 22 differs in the axial direction having a minimum inside diameter adjacent 62 adjacent the distal edge 34. The interior side wall 22 exhibits a maximum inside diameter adjacent the proximal edge 38. Because of the small value of the taper and a the size of the bearing retainer, the maximum outside diameter is only slightly greater than the minimum inside diameter 62.

The flexible web wall 24 is a curved wall coupled at an inner edge 36 to, and extending outwardly from, the proximal edge 38 of the interior side wall 22. In one illustrated embodiment, as shown, for example, in FIG. 4, the flexible web wall 24 has a slightly less than semi-circular cross section and exhibits a radius of curvature 40.

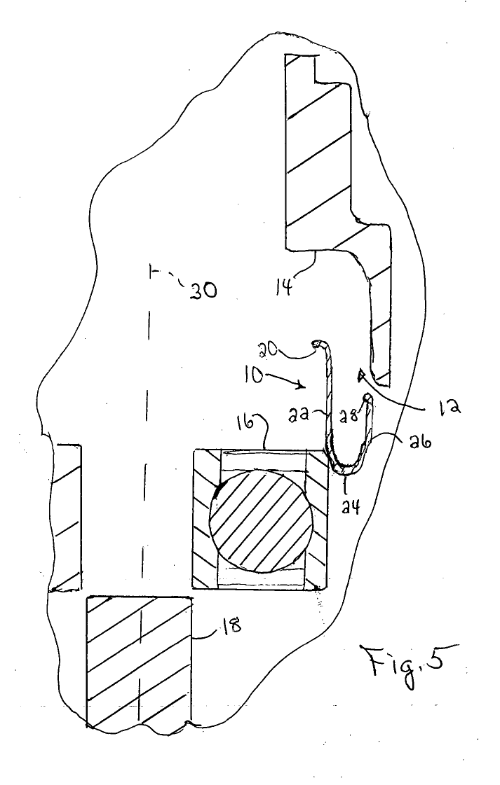

The compound bore-engaging exterior side wall 26 is coupled at a proximal edge 42 to, and extends distally from, an outer edge 44 of the flexible web wall 24. In the illustrated embodiment of bearing retainer 10, the compound bore-engaging side wall 26 includes an upper non-bore engaging portion 56, an offset web portion 58 and a bore-engaging portion 60. Since the web wall 24 in the illustrated embodiment is described as not having a complete semicircular cross-section, the non-bore engaging portion 56 of exterior side wall 26 exhibits a slight outward taper as it extends distally from the web relative to the interior side wall 22, as shown, for example, in FIGS. 4 and 5. However, because the exterior wall 26 includes an offset web portion 58 that offsets the bore engaging portion 60 radially outwardly from the interior side wall 22, it is within the scope of the disclosure for the web wall 24 to have a semicircular, or even slightly greater than a semicircular cross section, and for the non-engaging portion 56 to extend parallel to, or taper inwardly towards, the interior side wall 22.

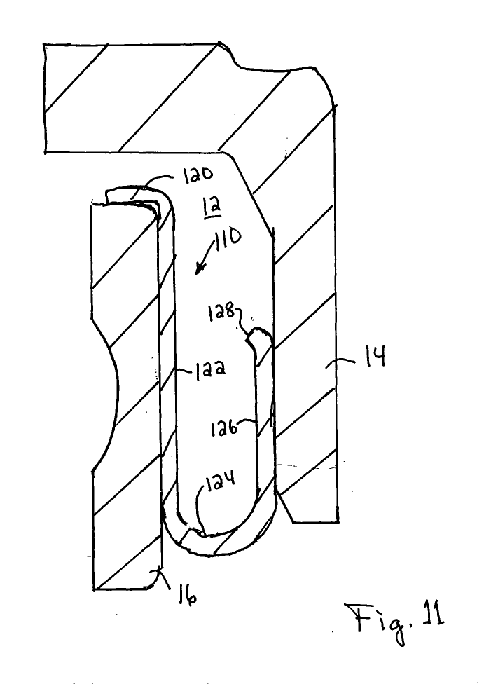

As shown for example in FIGS. 4-5, the connecting web portion 58 of outer wall 26 extends distally and outwardly from the distal end of the non-engaging portion 56 to the proximal end of the engaging portion 60 of outer wall 26. In the illustrated embodiment, the engaging portion 60, in its non deformed state, extends distally from the web portion 58 parallel to and offset radially outwardly from the interior side wall 22. Thus, the engaging portion 60 of the outer side wall 26 has an outside diameter 48 that is slightly greater than the inside diameter 80 (not shown in FIGS. 5-7 because of the partial nature of the cross-section, but shown in FIG. 10) of the cavity 12 into which the bearing retainer 10 is configured to be received.

Referring again to FIGS. 5-7, since the minimum inside diameter 62 of the interior side wall 22 is slightly less than the outside diameter 82 of the bearing 16 that the bearing retainer 10 is configured to receive, receipt of the bearing 16 in the bearing retainer 10 results in deformation of the bearing retainer 10. This deformation upon receipt of the bearing 16 in the bearing retainer 10 causes the engaging portion 60 of the outer side wall 26 to move outwardly with respect to the longitudinal axis 30 increasing the outside diameter of the deformed bearing retainer 10. Thus, it is within the scope of the disclosure for the non-deformed outside diameter 48 of the engaging portion 60 of the outer side wall 26 to be equal to or even slightly less than (by less than the anticipated outward deformation of the outer side wall 26 induced by receipt of the bearing 16 within the bearing retainer 10) the inside diameter 80 of the cavity 12. Nevertheless, it is preferred that the outside diameter 48 of the engaging portion 60 of the outer side wall 26 of the bearing retainer 10 be slightly greater than the inside diameter 80 of the cavity 12 into which it is designed to be received as it is preferred that the deformation of the bearing retainer 10 resulting from the insertion of the bearing 16 therein not be so great as to exert large forces on the outer race of the bearing 16 so as to avoid distortion of the outer race of the bearing 16.

In one specific embodiment wherein the outside diameter 82 of the bearing 16 is 35.0±0.1 mm and the inside diameter 80 of the bore or cavity 12 in frame or housing 14 is 42.0±0.1 mm, the minimum inside diameter 62 of the interior side wall 22 of the non-deformed bearing retainer 10 is 34.7±0.1 mm and the outside diameter 48 of the engaging portion 60 of the outer side wall 26 of the non-deformed bearing retainer 10 is 43.0±0.2 mm. While the above diameters 48 and 62 have proven adequate for the above applications, it is within the scope of the disclosure for the minimum inside diameter 62 of the interior side wall 22 of the non-deformed bearing retainer 10 to differ by a greater or lesser amount from the outside diameter 82 of the bearing 16 and for the outside diameter 48 of the engaging portion 60 of the outer wall 26 of the non-deformed bearing retainer 10 to differ by a greater or lesser amount from the inside diameter 80 of the cavity 12 in the housing 14. Preferably the minimum inside diameter 62 of the interior side wall 22 of the non-deformed bearing retainer 10 is determined based upon the outside diameter 82 of the bearing 16 with which the bearing retainer 10 is to be utilized, the desired retention force to be exerted on the bearing 16 by the bearing retainer 10 and the qualities of the material from which the bearing retainer 10 is fabricated. Preferably outside diameter 48 of the engaging portion 60 of the outer wall 26 of the non-deformed bearing retainer 10 is determined based upon the inside diameter 80 of the bore or cavity 12 in frame or housing 14 with which the bearing retainer 10 is to be utilized, the desired retention force to be exerted on the fame or housing 14 by the bearing retainer 10 and the qualities of the material from which the bearing retainer 10 is fabricated. For instance in a similar application, in a non-illustrated embodiment of the bearing retainer, the interior side wall 22 has an inside diameter of 35.0 mm at the proximal edge and the interior side wall 22 tapers inwardly as it extends distally with a 1° inward draft towards the distal edge adjacent the stop wall 20.

The tapered lead-in lip wall 28 is coupled at an outer edge 50 to, and extends inwardly and distally from, the distal edge 46 of the exterior side wall 26. The inner edge 52 of the ring-shaped lip wall 28 is displaced in the non-deformed bearing retainer 10 from the exterior surface of the interior wall 22 by a displacement 54. The tapered lip wall 28 facilitates pressing the bearing retainer 10 into the cavity 12 in the housing 14. As a result of pressing the bearing retainer 10 into the cavity 12, the web wall 24 is plastically deformed and the outer side wall 26 is displaced radially inwardly while the bearing engaging portion 60 of the outer side wall exerts a radially outwardly directed force against the wall of the cavity 12 to frictionally secure the bearing retainer 10 against rotational or longitudinal displacement relative to the housing 14. The displacement 54 is sufficient to allow the web wall 24 to be deformed during the insertion of the bearing retainer 10 into the cavity 12 in the housing 14.

As shown, for example, in FIGS. 1-4, a plurality of deformation channels 64 are formed extending through the web wall 24 and the non engaging portion 56 of the outer side wall 26. In the illustrated embodiment, the channels 64 extend radially through the web wall 24 and non-engaging portion 56 of the side wall 26. In the illustrated embodiment five channels 64 are formed in the bearing retainer 10 with each channel being equidistantly displaced from each of the adjacent channels 64. In the illustrated embodiment, the angular displacement between channels is seventy-two degrees. It is within the scope of the disclosure for more or less deformation channels 64 to be formed in bearing retainer 10, for such channels to not be equidistantly displaced from adjacent channels or for the channels to extend at an angle relative to a radius of the bearing retainer 10. While bearing retainer 110 is illustrated as not including deformation channels 64, it is within the scope of the disclosure for bearing retainer 110 to be formed to include one or more deformation channels 64. Similarly, it is envisioned that bearing retainer 10 could be formed with no deformation channels 64.

As shown for example, in FIGS. 5-7, the bearing 16 is inserted, preferably by pressing, into the bearing retainer 10. Because the interior side wall 22 has a smaller diameter 62 than the outside diameter 82 of the outside wall of the outer race of the bearing 16, pressing the bearing 16 into the bearing retainer 10 causes the bearing retainer 10 to be plastically deformed so that the inside diameter of the deformed bearing retainer 16 matches the outside diameter 82 of the bearing 16 this deformation causes the interior side wall 22 of the bearing retainer 10 to exert a radially inwardly directed force on the outer race of the bearing 16 thereby increasing the frictional forces that retain the bearing 16 against rotational or longitudinal displacement relative to the bearing retainer 10. As shown, for example, in FIGS. 6 and 7, preferably the bearing is pressed into the bearing retainer 10 until the bearing 16 engages the stop wall 20. However, it is envisioned that bearing retainer 10 may be formed without a stop wall 20.

The step of pressing the bearing 16 into the bearing retainer 10 deforms the bearing retainer 10 and slightly increase the outside diameter of the outer side wall 26. During the step of pressing the bearing retainer 10 into the cavity 12 of the housing 14, the web wall 24 is deformed as the side walls of the cavity urge the outer side wall 26 of the bearing retainer 10 radially inwardly. The plastic deformation of the web wall 24 creates a spring effect urging the outer side wall 26 to exert a radially outwardly directed force against the side wall of the cavity 12 to increase the frictional forces exerted between the outer side wall 26 of the bearing retainer 10 and the side wall of the cavity. While in the illustrated embodiment, the distal surface of the stop wall 20 is not in engagement with the floor wall of the cavity 12, it is within the scope of the disclosure for the bearing retainer 10 to be pressed into the cavity 12 far enough for the distal surface of the stop wall 20 to engage the floor or a lip of the cavity 12.

A bearing retainer or bearing retainer cup 110 in accordance with another disclosed embodiment is also configured for receipt in a cylindrical bore or cavity 12 formed in a housing or frame 14 and is configured to receive and retain a bearing 16 therein. The deformation of the bearing retainer 110 when the bearing 16 is inserted into the retainer 110 and when the retainer 110 is inserted into the cavity 12 of the housing 14 is similar to that described above with regard to bearing retainer 10 and will not be described in detail with regard to bearing retainer 110.

The bearing retainer 110 includes a ring-shaped stop wall 120, a slightly tapered, substantially cylindrical bearing-engaging interior side wall 122, a flexible web wall 124, a tapered bore-engaging exterior side wall 126 and a lip wall 128. Prior to utilization, the ring-shaped stop wall 120, interior side wall 122, flexible web wall 124, exterior side wall 126 and lip wall 128 are all formed concentrically about an axis 130. However, in use, as shown for example, in FIGS. 10 and 11, certain of the walls of the bearing retainer 110 are deformed to facilitate securing the bearing 16 within the retainer 110 and the retainer 110 within the bore or cavity 12 in the housing or frame 14. Thus, the bearing retainer 110 is formed from appropriate materials to allow for the deformation of the bearing retainer 110 in use and to securely hold the bearing 16 in the desired position and orientation relative to the housing or frame 14 in which it is inserted. In one example, the bearing retainer 110 is fabricated from sheet metal such as 22ga. (thickness) AISI/SAE 1008, 1010 or 1015 low carbon steel sheet or strip metal as described with regard to retainer 10 above.

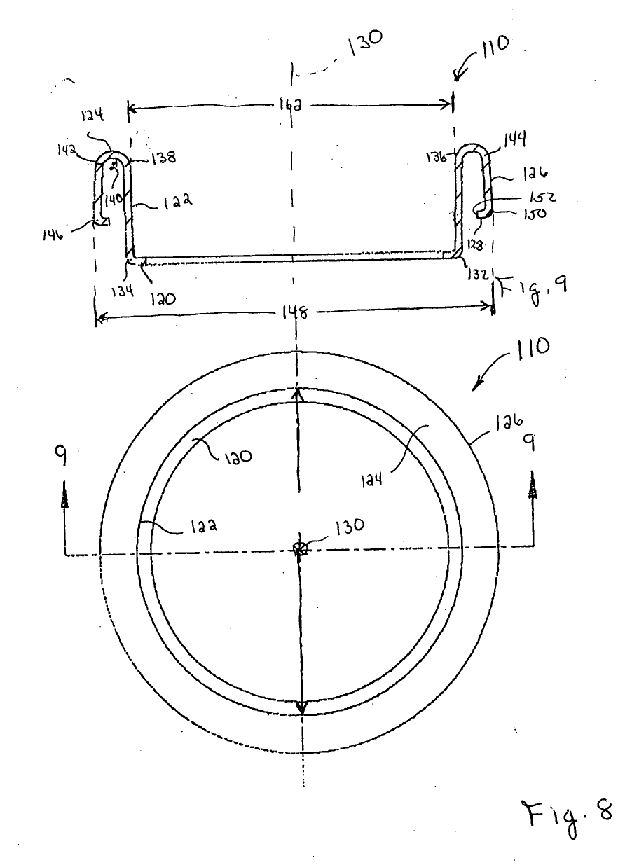

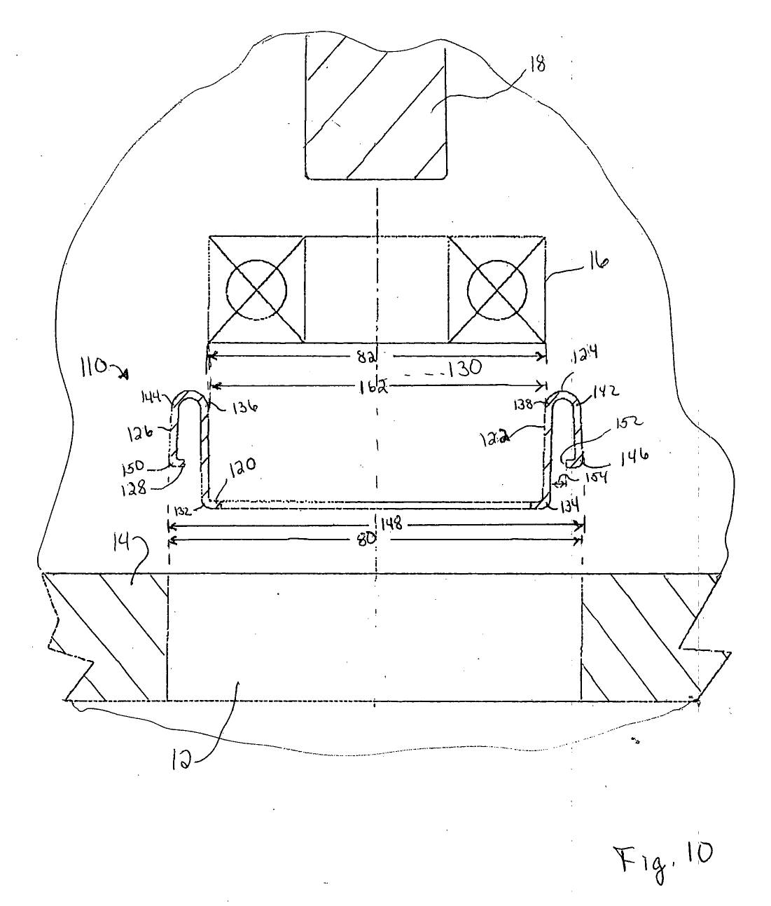

FIGS. 8-10 show the bearing retainer 110 in a non-deformed state prior to insertion into a bore or cavity 12 and prior to receiving a bearing 16. As shown, for example, in FIGS. 8-10, ring-shaped stop wall 120 is coupled at an outer edge 132 to, and extends inwardly from, a distal edge 134 of the bearing-engaging interior side wall 122. To facilitate fabrication of the bearing retainer 110, the junction between the stop wall 120 and side wall 122 may be radiused. The flexible web wall 124 is a curved wall coupled at an inner edge 136 to, and extending outwardly from, the proximal edge 138 of the interior side wall 122. In one illustrated embodiment, as shown, for example, in FIGS. 9 and 10, the flexible web wall 124 has a slightly less than semi-circular cross section and exhibits a radius of curvature 140. The bore-engaging exterior side wall 126 is coupled at a proximal edge 142 to, and extends distally from, an outer edge 144 of the flexible web wall 124. Since the web wall 124 in the illustrated embodiment does not have a complete semicircular cross-section, the exterior side wall 126 exhibits a slight outward taper as it extends distally from the web wall 124 relative to the interior side wall 122, as shown, for example, in FIGS. 9 and 10. Thus, the outer side wall 126 in its non-deformed state has a maximum outside diameter 148 that is slightly greater than the inside diameter 80 of the cavity 12. The ring-shaped lip wall 128 is coupled at an outer edge 150 to, and extends inwardly from, the distal edge 146 of the exterior side wall 126. The inner edge 152 of the ring-shaped lip wall 128 is displaced from the exterior surface of the interior wall 122 by a displacement 154.

In one specific embodiment wherein the outside diameter 82 of the bearing 16 is 35±0.1 mm and the inside diameter 80 of the bore or cavity 12 in frame or housing 14 is 42±0.1 mm, the minimum inside diameter 162 of the inner wall 122 of the non-deformed bearing retainer 110 is 34.7±0.1 mm and the maximum outside diameter 148 of the outer side wall 126 of the non-deformed bearing retainer 110 is 43±0.2 mm. While the above diameters 148 and 162 have proven adequate for the above applications, it is within the scope of the disclosure for the inside diameter 162 of the inner wall 122 of the non-deformed bearing retainer 10 to differ by a greater or lesser amount from the outside diameter 82 of the bearing 16 and for the outside diameter 148 of the outer wall 126 of the non-deformed bearing retainer 110 to differ by a greater or lesser amount from the inside diameter 80 of the cavity 12 in the housing 14. Preferably the inside diameter 162 of the inner wall 122 of the non-deformed bearing retainer 110 is determined based upon the outside diameter 82 of the bearing 16 with which the bearing retainer 110 is to be utilized, the desired retention force to be exerted on the bearing 16 by the bearing retainer 110 and the qualities of the material from which the bearing retainer 110 is fabricated. Preferably outside diameter 148 of the outer wall 126 of the non-deformed bearing retainer 110 is determined based upon the inside diameter 80 of the bore or cavity 12 in frame or housing 14 with which the bearing retainer 110 is to be utilized, the desired retention force to be exerted on the fame or housing 14 by the bearing retainer 110 and the qualities of the material from which the bearing retainer 110 is fabricated.

The disclosed bearing retainers 10 and 110 have particular utility in alternators, generators, motors and other electromechanical devices that include a shaft 18 that is either driven by or drives a rotating armature. The disclosed bearing retainers 10 and 110 have been designed and configured for use in automotive application of such above described electromechanical devices. Despite their particular utility in automotive electromechanical devices, the disclosed bearing retainers 10 and 110 may be utilized in other applications where it is desirable to secure a bearing 16 relative to a housing 14 wherein manufacturing tolerance of the bearing and housing might otherwise result in an insecure mounting of the bearing or deformation of the bearing to the point that its functionality is degraded without the use of the bearing retainer 10, 110.

Both illustrated embodiments of bearing retainer 10, 110 and other non-illustrated embodiments are designed to hold bearings 16 in bores or cavities 12 formed in machine frames or housings 14. The bearing retainers 10, 110 are configured such that when pressed into the bore 12 a force is generated by a spring effect from the outer wall 26, 126 being compressed into the bore 12 thereby inducing elastic and plastic deformation of the web wall 24, 124. This spring force is sufficient to hold the retainer 10, 110 in place against both rotational forces due to the bearing 16 turning and against forces along the longitudinal axis 30, 130 normal to the rotation of the bearing 16 due to vibration and thermal effects.

Because the interior side wall 22, 122 of the disclosed retainers 10, 110 have a minimum inside diameter 62, 162 slightly less than the outside diameter of the bearing 16 to be received therein, upon pressing the bearing 16 into the retainer 10, 110, the interior side wall 22, 122 is plastically deformed to match the outside diameter of the bearing 16. In the described embodiments the material from which the retainer 10, 110 is fabricated is selected such that a large separation exists between the yield of the material from which the outer race of the bearing 16 is fabricated and the yield of the material from which the retainer 10, 110 is fabricated. Thus, the forces exerted on the outer race of the bearing 16 when received in the bearing retainer 10, 110 are small enough that the outer race of the bearing 16 is not deformed or distorted as a result of being received within the retainer 10, 110. Additionally, the disclosed bearing retainers 10, 110 can be manufactured to less demanding tolerances than is required for the prior art thermoplastic bearing retainers.

The disclosed bearing retainers 10, 110 are configured and fabricated to act as axial springs to reduce the axial play of the bearing 16 when assembled into a system. Thus, the disclosed bearing retainer 10, 110 reduces the need for separate springs to axially load the bearing 16 as is often required when thermoplastic inserts are utilized. Due to the high press loads which may be experienced by the bearing retainer 10, 110, wherein stresses may locally exceed the yield of the material from which the bearing retainer is fabricated, plasticity analysis may be utilized to account for plastic deformation of the bearing retainer 10, 110 during assembly of the bearing 16 to the housing 14 and to facilitate selection of the material from which the bearing retainer 10, 110 is fabricated. It is preferable that the bearing retainer 10, 110 be configured and fabricated to encourage good assembly behavior, reduce local strains, and reduce the complexity of fabrication. Strain values within the material from which the bearing retainer 10, 110 is fabricated preferably won't exceed the desired maximal axial bearing load. Additionally, it is preferable that the bearing retainer 10, 110 have an adequate but limited axial stiffness and a high radial stiffness for the application in which the retainer 10, 110 is to be utilized. For example, in a rotor type application, such as when the bearing retainer 10, 110 is utilized in a motor, generator or alternator, the axial stiffness of the bearing retainer 10, 110 may desirably be greater than two hundred Hertz and the radial stiffness of the bearing retainer 10, 110 may be on the order of four hundred Hertz.

Although the invention has been described in detail with reference to certain preferred or illustrative embodiments, variations and modifications exist within the scope and spirit of the invention as described and as defined in the claims

What is claimed is:

1. A bearing retainer for use with a bearing having an outside diameter which is to be received in the bearing retainer and to be mounted into a cavity having an inside diameter, the bearing retainer comprising:
a frusto-conical inner bearing-engaging wall having a minimum inside diameter when the bearing retainer is in a non-deformed state approximately equal to but slightly less than the outside diameter of the bearing to be received therein;
an outer cavity-engaging wall having a maximum outside diameter when the bearing retainer is in a non-deformed state approximately equal to the inside diameter of the cavity within which the bearing retainer is to be received;
a web wall extending between and coupling the bearing-engaging wall and the cavity-engaging wall;
and wherein the bearing-engaging wall, cavity-engaging wall and web wall are fabricated from a material capable of elastic and plastic deformation so that upon insertion of the bearing into the bearing retainer the bearing-engaging wall is deformed to secure the bearing within the bearing retainer and upon insertion of the bearing retainer into the cavity the web wall is deformed to induce the cavity-engaging wall to exert a force against a side wall of the cavity to secure the bearing retainer within the cavity.

2. The bearing retainer of claim 1 and further comprising a stop wall extending inwardly from a distal edge of the bearing-engaging wall.

3. The bearing retainer of claim 1 wherein the web wall extends between a proximal edge of the bearing-engaging wall and a proximal edge of the cavity-engaging wall.

4. The bearing retainer of claim 3 wherein a distal end of the cavity-engaging wall is spaced apart from the bearing engaging wall.

5. The bearing retainer of claim 4 wherein a lip extends distally and radially inwardly from the distal end of the cavity engaging wall terminating in a free end displaced from the bearing-engaging wall.

6. The bearing retainer of claim 5 wherein the bearing is configured to facilitate stamping the bearing retainer as a monolithic component from a sheet of metal.

7. The bearing retainer of claim 6 wherein the sheet of metal from which the bearing retainer is formed has a thickness of between 0.025 and 0.035 inches.

8. The bearing retainer of claim 6 wherein the metal from which the bearing retainer is fabricated is a low carbon steel.

9. The bearing retainer of claim 8 wherein the metal from which the bearing retainer is fabricated is selected from the group of AISI 1008, AISI 1010 and AISI 1015 low carbon steel.

10. The bearing retainer of claim 6 wherein the metal from which the bearing retainer is fabricated is stainless steel.

11. The bearing retainer of claim 1 wherein the maximum outside diameter of the cavity-engaging wall in a non-deformed bearing retainer is slightly greater than the inside diameter of the cavity.
